(19) United States
(12) Patent Application Publication
(10) Pub. No.: US 2024/0121590 A1
(43) Pub. Date: Apr. 11, 2024

(54) Systems and Method for Roaming in Wi-Fi Networks

(71) Applicant: ZEBRA TECHNOLOGIES CORPORATION, Lincolnshire, IL (US)

(72) Inventors: Subramani Rajendiran, Bangalore (IN); Sandeep Ramakrishnan, Bangalore (IN); Ohad Shatil, Dunwoody, GA (US); Jonathan Chen, Medford, NY (US)

(21) Appl. No.: 18/375,790

(22) Filed: Oct. 2, 2023

Related U.S. Application Data
(60) Provisional application No. 63/413,496, filed on Oct. 5, 2022.

(51) Int. Cl. H04W 8/08; H04W 12/037; H04W 12/06

(52) U.S. Cl. CPC H04W 8/08; H04W 12/037; H04W 12/06

(57) ABSTRACT

Systems and method for wireless roaming include operating, via a wireless communication device, a first communication link between the wireless communication device and a first access point using a first media access control (MAC) layer of the wireless communication device; initiating, using a second MAC layer of the wireless communication device, a roaming handover with a second access point while the first communication link remains configured for transmitting and receiving application and/or IP layer communication packets; ceasing transmission and reception of the application and/or IP layer communication packets via the first communication link after the roaming handover has been initiated; and resuming transmission and reception of the application and/or IP layer communication packets with a second communication link between the wireless communication device and the second access point upon completion of the roaming handover.

### RELATED APPLICATIONS

The present application claims priority to and the benefit of U.S. Provisional Patent Application No. 63/413,496, filed on Oct. 5, 2022, which is incorporated by reference herein in its entirety.

### BACKGROUND

Roaming provides wireless communication devices or stations with the ability to roam between different access nodes or points in a wireless network by allowing the stations to terminate a communication link with one access point and establish a new communication link with another access point, e.g., as the device moves through a facility into and out of range of the access points or for other reasons, such as service capacity or connection limits of the access points. In a roam handover for Wi-Fi networks based on the IEEE 802.11 standards, a station typically suspends data transmission and reception operations on an active communication link with an access point and begins a process to establish a new communication link with a different access point. After the new active communication link has been established on the different access point, the mobile device resumes data transmission and reception operations with the different access point using the new active communication link. The interruption in communication while establishing the new communication link can result in jitter, roam delays, and packet loss. The duration of time required to establish the new communication link can be significant due to various sources of delays both on the device side and network side. As an example, for some configurations, assuming no connection failures, a conventional roaming handover can take approximately fifty (50) to sixty (60) milliseconds with a loss of approximately two (2) to four (4) voice packets. However, when connection failures occur the time required to establish the new communication link can be significantly longer. The inclusion of Extensible Authentication Protocol (EAP) authentication and key exchange when establishing the new communication link can result in an additional interruption of communication and can cause several seconds of interruption and/or full disconnections.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIGS. 1A-C illustrates a block diagram of a network 100 to which a wireless communication device or station can connect in accordance with embodiments of the present disclosure.

FIG. 2 is a dataflow diagram of an example make-before-break roam handover process utilizing independently controlled MAC layers in accordance with embodiments of the present disclosure.

FIG. 3 is a dataflow diagram of another example make-before-break roam handover process utilizing independently controlled MAC layers in accordance with embodiments of the present disclosure.

FIG. 4 is a dataflow diagram of another example make-before-break roam handover process utilizing independently controlled MAC layers and one band of a target access point as a proxy for another band of the target access point in accordance with embodiments of the present disclosure.

FIG. 5 is a dataflow diagram of an example partial make-before-break roam handover process utilizing independently controlled MAC layers in accordance with embodiments of the present disclosure.

FIG. 6 is a dataflow diagram illustrating another example partial make-before-break roam handover process utilizing independently controlled MAC layers in accordance with the embodiments of the present disclosure.

FIG. 7 is a dataflow diagram illustrating an example make-before-break roam handover process for communication using a multi-link operation (MLO) in accordance with the embodiments of the present disclosure.

FIG. 8 is a block diagram of an example embodiment of a station in accordance with the embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The components of embodiments of the present disclosure have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Roam handovers introduce latency which can be disruptive to network communication. Embodiments of the present disclosure advantageously reduce or eliminate the impact of roam handovers to network communication, even when connection failures occur during the roaming process, by simultaneous operating multiple hardware links, typically used for operation across multiple bands (scanning, or multi-link operation). Embodiments of the present disclosure can significantly reduce or potentially eliminate jitter and packet loss in roam scenarios.

Embodiments of the present disclosure can simultaneously utilize independently operated Medium Access Control (MAC) layers of a wireless communication device or station to establish communication links to separate access points during a roam handover, and transfer control between access points. Embodiments can include full “make-before-break” roaming handovers and “partial make-before-break” roaming handovers. For embodiments that utilize full make-before-break roaming handovers, management frames (e.g., MAC layer communication packets; layer 2 communication packets under the OSI model) necessary to establish a new communication link with a second access point during a roaming handover can be performed using a second MAC layer while higher level communication packets (e.g., application and/or IP layer communication packets; layer 3 communication packets and above under the OSI model) can continue on an existing communication link between a first MAC layer and a first access point until the station and/or the new communication link is ready to transmit and receive higher level communication packets (e.g., application and/or IP layer communication packets; layer 3 communication packets and above under the OSI model) on the new communication link. Once the station and/or the new communication link is ready to begin transmitting and receiving application and/or IP layer communication packets (e.g., layer 3 communication packets or above under the OSI model) between the second MAC layer and second access point, a specified/designated operation is performed by the station to transfer control to the new communication link and terminate the previously existing communication link such that transmission and reception of application and/or IP communication packets ceases on the previously existing communication link and resumes on the new communication link. For embodiments that utilize partial make-before-break roaming handovers, independently operated MAC layers are used to add parallelism to roaming operations, reducing latency from the exchange of management frames (e.g., MAC layer communication packets; layer 2 under the OSI model), as well as additional hardware operations, by allowing the existing communication link to continue to transmit and receive application and/or IP layer communication packets (e.g., layer 3 communication packets or above under the OSI model) for at least a portion of the time required for the new communication link to be configured to transmit and receive application and/or IP layer communication packets (e.g., layer 3 communication packets or above under the OSI model).

In accordance with embodiments of the present disclosure, a method for wireless roaming is disclosed that includes operating, via a wireless communication device, a first communication link between the wireless communication device and a first access point using a first media access control (MAC) layer of the wireless communication device, initiating, using a second MAC layer of the wireless communication device, a roaming handover with a second access point while the first communication link remains configured to transmit and receive application or IP layer communication packets, ceasing transmission and reception of the application or IP layer communication packets on the first communication link after the roaming handover has been initiated, and resuming the application or IP layer communication packets with a second communication link between the wireless communication device and the second access point upon completion of the roaming handover.

In accordance with embodiments of the present disclosure, a wireless communication device is disclosed. The wireless communication device includes one or more antennas, one or more radiofrequency transceivers, a first media access control layer, and a second media access control layer. The one or more radiofrequency transceivers are configured to transmit and receive radiofrequency signals via the one or more antennas. The first media access control (MAC) layer is configured to operate a first communication link between the wireless communication device and a first access point. The second media access control (MAC) layer is configured to initiate a roaming handover with a second access point while transmission and reception of application or IP layer communication packets continues on the first communication link. Transmission and reception of the application or IP layer communication packets ceases on the first communication link after the roaming handover has been initiated. Transmission and reception of the application or IP layer communication packets resumes on a second communication link between the wireless communication device and the second access point upon completion of the roaming handover.

In accordance with embodiments of the present disclosure, resuming transmission and receipt of the application or IP layer communication packets with the second communication link include resuming transmission and reception of the application or IP layer communication packets using the first MAC layer of the wireless communication device.

In accordance with embodiments of the present disclosure, initiating the roaming handover includes transmitting an authentication request from the wireless communication device to the second access point using the second MAC layer.

In accordance with embodiments of the present disclosure initiating the roaming handover further includes receiving an authentication reply from the second access point and sending an authentication ready signal from the second MAC layer to the first MAC layer. The wireless communication device ceases transmission and reception of the application or IP layer communication packets via the first communication link in response to the authentication ready signal.

In accordance with embodiments of the present disclosure, a reassociation request is transmitted from the wireless communication device to the second access point using the first MAC layer and transmission and reception of the application or IP layer communication packets is resumed using the second communication link.

In accordance with embodiments of the present disclosure, security and encryption frames are exchanged between the wireless communication device and the second access point and the encryption key is installed on the wireless communication device. The exchange of security and encryption frames and installation of the encryption key are performed prior to resuming transmission and reception of the application or IP layer communication packets using the second communication link.

In accordance with embodiments of the present disclosure, initiating the roaming handover includes transmitting an authentication request from the wireless communication device to the second access point using the second MAC layer and a first frequency band, transmitting a reassociation request from the wireless communication device to the second access point using the second MAC layer and the first frequency band, and exchanging security and encryption frames with the second access point using the second MAC layer and the first frequency band. Initiating the roaming handover also includes sending a new link read signal from the second MAC layer to the first MAC layer after exchanging the security and encryption frames, installing the encryption key on the first MAC layer, and resuming transmission and reception of the application or IP layer communication packets via the second communication link using the first MAC layer and a second frequency band of the second access point. The wireless communication device ceases transmission and reception of the application layer communication via the first communication link in response to the new link ready signal.

In accordance with embodiments of the present disclosure, resuming transmission and reception of the application or IP layer communication packets with the second communication link includes resuming transmission and reception of the application or IP layer communication using the second MAC layer of the wireless communication device.

In accordance with embodiments of the present disclosure, initiating the roaming handover includes transmitting an authentication request from the wireless communication device to the second access point using the second MAC layer, transmitting a reassociation request from the wireless communication device to the second access point using the second MAC layer, in response to the reassociation response, sending a new link ready signal from the second MAC layer to the first MAC layer. Transmission and reception of the application or IP layer communication packets is resumed using the second communication link and the wireless communication device ceases transmission and reception of the application or IP layer communication packets via the first communication link in response to the new link ready signal.

In accordance with embodiments of the present disclosure, security and encryption frames are exchanged with the second access point and the encryption key is installed, wherein exchanging and installing are performed prior to resuming transmission and reception of the application or IP layer communication packets using the second communication link and after the new link ready signal is sent.

In accordance with embodiments of the present disclosure, security and encryption frames are exchanged with the second access point and the encryption key are installed, wherein exchanging and installing are performed prior to resuming transmission and reception of the application or IP layer communication packets using the second communication link and before the new link ready signal is sent.

In accordance with embodiments of the present disclosure, initiating, using the second MAC layer of the wireless communication device, a roaming handover with the second access point while the first communication link remains configured for transmission and reception of the application or IP layer communication packets includes establishing the second communication link that is limited to performing the MAC layer operations for the roam handover until the second communication link is ready to transmit and receive the application or IP layer communication packets in response to an action event signal that is transmitted to the second access point.

In accordance with embodiments of the present disclosure, the wireless communication device utilizes multi-link operation (MLO) communication for the first communication link in which the wireless communication device uses the first MAC layer to communicate with the first access point using a first frequency band or a first channel and uses the second MAC layer to communicate with the first access point using a second frequency band or a first channel. In response to initiating the roam handover, the wireless communication device ceases the MLO communication on the second MAC layer while the first communication remains between the wireless communication device and the first access point using the first MAC layer and the first frequency band or the first channel. The wireless communication device uses the second MAC layer to initiate the roam handover with the second access point.

In accordance with embodiments of the present disclosure, initiating the roaming handover includes transmitting an authentication request from the wireless communication device to the second access point using the second MAC layer and a first frequency band or a first channel of the second access point, transmitting a reassociation request from the wireless communication device to the second access point using the second MAC layer and the first frequency band or the first channel of the second access point, exchanging security and encryption frames with the second access point using the second MAC layer and the first frequency band or the first channel of the second access point, installing the encryption key on the second MAC chain, sending a new link read signal from the second MAC layer to the first MAC chain, and resuming transmission and reception of the application or IP layer communication packets via the second communication link using the second MAC layer and the first frequency band or the first channel of the second access point. The wireless communication device ceases transmission and reception of the application or IP layer communication packets via the first communication link in response to the new link ready signal.

In accordance with embodiments of the present disclosure, the MLO communication is established between the wireless communication device and the second access point using a second frequency band or a second channel of the second access point and the first MAC chain.

In accordance with embodiments of the present disclosure, the second communication link is established before the first communication link ceases transmission and reception of the application or IP layer communication packets and is utilized for transmission and reception of the application or IP layer communication packets after the first communication link ceases transmission and reception of the application or IP layer communication packets.

In accordance with embodiment of the present disclosure, the first MAC layer and the second MAC share a physical hardware address and have different virtual hardware addresses.

In accordance with embodiments of the present disclosure, the first MAC layer and the second MAC layer share a virtual hardware address and have different physical hardware addresses.

In accordance with embodiments of the present disclosure, the second MAC layer spoofs the hardware address of first MAC chain.

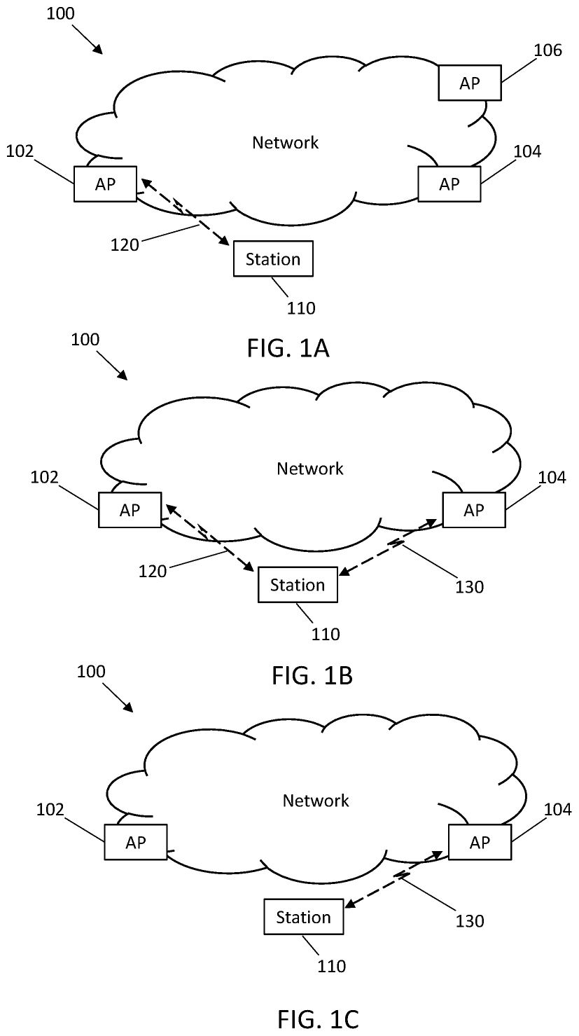

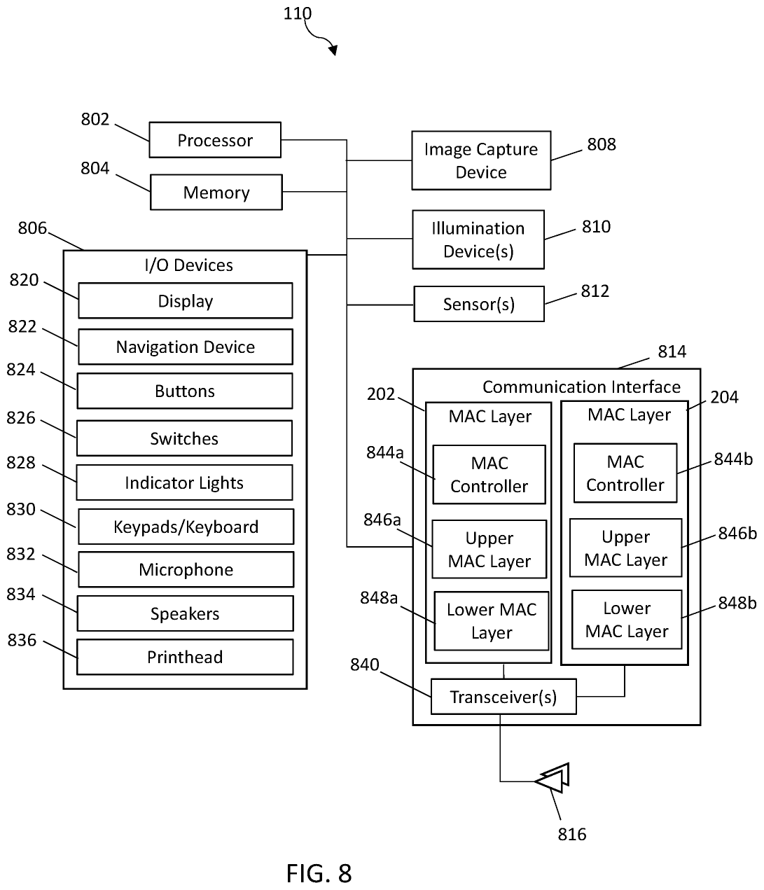

FIGS. 1A-C illustrates a network 100 in accordance with embodiments of the present disclosure. The wireless network 100 includes one or more radiofrequency transceiver network devices/nodes, such as access points 102 and 104, that allow a wireless communication device or station 110 to wirelessly connect to the network 100. The access points 102 and 104 can be connected to other wired and wireless devices in the network 100 (e.g., access points, switches, routers, hubs, gateways, servers, etc.). The station 110 includes radiofrequency one or more transmitters and one or more receivers for transmitting and receiving radiofrequency communication packets, such as communication packets for voice over IP, video, other data packets, control frames, network management frames, and/or other radio communication signals. An example embodiment of the station 110 is shown in FIG. 8. The station 110 can communicate wirelessly with one of the access points 102 and 104 to facilitate communication with other devices on the network 100 and with other networks and device connected to the other networks. In one example, the network 100 can be a wireless local area network (WLAN) and/or the station 110 can wirelessly connect to one of the access points 102 and 104 to form a communication session (that includes a session identifier) using standardized protocols such as the protocols defined by the IEEE 802.11 standards, commonly referred to as Wi-Fi. These industry standards allow communication sessions to be established and maintained via a wireless communication link (a wireless connection between devices that has been established by the device to enable the transmission and reception communication packets) between the station 110 and one of the access points 102 and 104 for the transmission and reception of application and/or IP layer communication packets (e.g., layer 3 communication packets or above under the OSI model) in the form of radiofrequency signals carrying data or information.

Initially, as illustrated in FIG. 1A, the station 110 can establish a connection (a communication link denoted by reference number 120) with one of the access points (e.g., the access point 102) of the network 100 using MAC layer communication packets (e.g., layer 2 communication packets under the OSI model) based on a device discovery or scanning process, an authentication process, and an association process. The scanning process can be used by the station 110 to identify access points in the network 100 to which the station 110 can wirelessly connect. Generally, there are two scanning processes that can be employed for identifying access points: passive scanning and/or active scanning. In the passive scanning process, the station 110 waits for beacon frames transmitted by the access points to communicate or to identify the access points. The beacon frames can include a timestamp, a rate at which the beacons are transmitted by the access point (a beacon interval), information related to capabilities of the access point or network, the service set identifier (SSID) of the network, and supported data rates of the access point. In the active scanning process, the station 110 transmits a probe request management frame to discover access points and their associated network(s) (service set identifiers, SSIDs, and/or basic service set identifier, BSSIDs). If an access point receives the probe request management frame, the access point transmits a probe response frame back to the station 110.

Once the station 110 identifies an access point (e.g., the access point 102) with which to establish a connection (a communication link) based on the scanning process, the station 110 begins the authentication process and exchanges authentication frames with the access point 102. The authentication frames can include an authentication request that is used by the access point 102 to verify that capabilities of the station 110 are compatible with the network. An authentication response can be transmitted to the station 110 from the access point 102 in response to the authentication request, where the authentication response can indicate whether authentication was successful.

If successful completion of the authentication process, the station 110 begins the association process, which include communication exchanges between the station 110 and the access point 102. In the association process, the station 110 transmits an association request frame to the access point 102. The access point 102 transmits an association response frame to the station 110 in response to the association request frame, which establishes the connection between the station 110 and the access point 102 and provide the station with access to the network 120.

The process can include additional authentication steps before fully establishing the connection between the station 110 and the access point 102. For example, before a connection is fully established, the network 100 may require successful Extensible Authentication Protocol (EAP) authentication and key exchange before fully establishing the connection between the station 110 and the access point 102. Using the established communication link 120, the station 110 and the access point 102 can transmit and receive application and/or IP layer communication packets (e.g., layer 3 communication packets or above under the OSI model).

At any given time, the station 110 can be within range of more than one access point. For example, as illustrated in FIG. 1B, the station 110 may be wirelessly connected to (associated with) the access point 102 via communication link 120 to provide the station 110 access to the network 100 (enabling transmission and reception of application and/or IP layer communication packets) and may be or may come within range of the access point 104. The station 110 can initiate a roaming handover, as shown in FIG. 1B, to establish a new communication link with the access point 104; which is determined to be within range of the station 110 based on performance of the scanning process. Upon completion of the roaming handover, as shown in FIG. 1C, the station 110 can have an established communication link (denoted by reference number 130) with the access point 104 and previous communication link 120 with the access point 102 can be terminated. The roaming handover generally must be completed within a defined time interval (e.g., a few seconds) to avoid the station 110 being disconnected from the network 100. In a conventional roaming process, a station typically would send a disassociation frame to the access point 102 with which is already has an established communication link to cease communication between the station 110 an the access point 102 and would subsequently start a reassociation process by performing the scanning, authentication, and (re-)association processes with the access point 104 to which the station 110 is attempting to establish the new communication link. The duration of time required to establish the new communication link with the new access point 104 after the station 110 is disassociated from the access point 102 with which it previously had a communication link can be significant and the interruption in communication while establishing the new communication link can result in jitter, roam delays, packet loss, interruptions, and even full disconnections.

Embodiments of the station 110, access points 102 and 104, and/or the network 100 can be configured to facilitate make-before-break roaming and partial make-before-break roaming. As an example, as shown in FIG. 1B, the station 110, access points 102 and 104, and/or the network 100 can be configured to enable the station 110 to initiate a roaming handover to establish the new communication link 1130 with a new access point without the station 110 having to first disassociate or disconnect from the access point 102 for which the communication link 120 exists, allowing the station 110 and the access point 102 to continue to transmit and receive application and/or IP layer communication packets (e.g., layer 3 communication packets or above under the OSI model) using the communication link 120 while the new communication link 130 is being established. The station 110 can be configured to leverage two independently operated media access control (MAC) layers to facilitate make-before-break and partial make-before-break roaming. The first MAC layer can be used to manage the existing communication link 120 with the access point 102 and the second MAC layer can be used to at least initiate the roaming process, and in some instances, to fully establish the new communication link 130 with another access point (e.g., the access point 104. Configuring the station 110, the access points 102 and 104, and/or the network 120 to perform make-before-break and partial make-before-break roaming can advantageously reduce or eliminate issues associated with roaming handovers, e.g., can reduce jitter, roam delays, delays associated with connection failures, and packet loss and/or can prevent interruptions and/or fa disconnections.

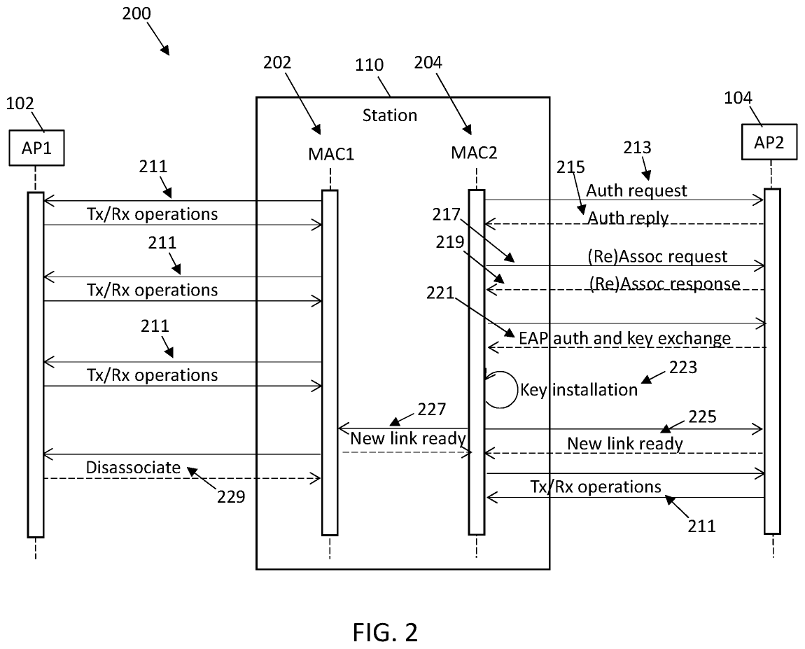

FIG. 2 illustrates an example roam handover process 200 in accordance with embodiments of the present disclosure. As shown in FIGS. 1A-C and 2, the station 110 can operate two medium access control (MAC) layers 202 and 204. The station 110 can operate the MAC layers 202 and 204 independently. As an example, one MAC layer can operate on a 2.4 GHz band and the other MAC layer can operate on a 5/6 GHz band. As another example, the device can operate the MAC layers on the 5 and 6 GHz bands independently (e.g., one MAC layer on the 5 GHz band and the other MAC layer on the 6 GHz band) and/or the station 110 can operate the MAC layers in the same band on separate channels or sub-bands. The process 200 can utilize the MAC layers 202 and 204 to facilitate roaming between access points (e.g., access points 102 and 104) while maintaining an operable communication link with one of the access points for transmitting and receiving application and/or IP layer communication packets (e.g., layer 3 communication packets and/or above under the OSI model) until an action event from the station 110 causes a transition to the new communication link (e.g., when the station 110 and/or the new communication link 130 is ready for transmission and reception of application and/or IP layer communication packets).

The station 110, using the MAC layer 202 can have an established communication link (e.g., the communication link 120 shown in FIG. 1A-B) with the access point 102 over which the station 110 and the access point 102 can perform transmit and receive operations 211 to transmit and receive application and/or IP layer communication packets (e.g., layer 3 communication packets and/or above under the OSI model). To establish a new communication link (e.g., the communication link 130 shown in FIGS. 1B-C) to access point 104 during a roam handover, the station 110 can use the inactive MAC layer 204 while the existing communication link 120 between the active MAC layer 202 and the access point 102 remains configured to transmit and receive application and/or IP layer communication packets (denoted by arrows 211 for transmit and receive operations). For example, using the MAC layer 204, the station 110 can perform MAC layer operations including, but not limited to MAC level communication packets (e.g., layer 2 under the OSI model) for discovery and management operations involved in establishing the new communication link 130 with the access point 104 (e.g., based on the IEEE 802.11 standards), as well as any necessary security-related operations, such as authentication and key exchange. The station 110 and the access point 104 can perform the authentication process to transmit and receive authentication frames including an authentication request 213 transmitted by the station 110 (using MAC layer 204) and received by the access point 104 and an authentication response 215 transmitted by the access point 104 and received by the station 110 (using MAC layer 204). The station 110 and the access point 104 can perform the association process to transmit and receive (re)association frames including a reassociation request 217 transmitted by the station 110 (using MAC layer 204) and received by the access point 104 and a reassociation response 219 transmitted by the access point 104 and received by the station 110 (using MAC layer 204). The station 110 (using MAC layer 204) and the access point 104 can perform an additional authentication process to transmit and receive EAP authentication and key exchange frames 221, after which the station 110 can install the key 223. In some instances, a connection error may occur during the roaming process 200. As an example, the station 110 can fail to establish the new communication link 130 with the access point 104 and may attempt to establish the new communication link with the access point a configured number of times and/or upon failure (or the nth failure) may attempt to form a new communication link with another access point (e.g., a further or third access point 106). Since the existing communication link 120 remains configured for transmit and receiver operations 211 to transmit and receive application or IP level communication packets while the new communication link is being established, connection errors during the roaming process 200 have no impact on network communication. After the discovery, management, and security related operations involved in establishing the new communication link 130 with the access point 104 are completed, using the MAC layer 204, the station 110 can transmit a specified/designated signal or action event (new link ready signal) 225 to the access point 104 and a specified/designated signal 227 to the MAC layer 202 to transition from the existing communication link 120 between the station 110 and the access point 102 (using the MAC layer 202) to the new communication link 130 established between the station 110 (using the MAC layer 204) and the access point 104. Upon receiving the new link ready signal 225, the access point 104 can update and/or distribute the association table in the network 100. After the designated signals 225 and 227 are transmitted, the station 110 (using the MAC layer 202) can transmit a disassociate frame 229 to the access point 102 to cease transmitting and receiving communication packets on the existing communication link and terminate the previously existing communication link 120 and the station 110 (using the MAC layer 204) and the access 104 can resume the transmit and receive operations 211 for transmitting and receiving application or IP communication packets (e.g., layer 3 communication packets and/or above under the OSI model) on the new communication link 130. Using this approach, the new communication link 130 between the station 110 and the access point 104 can be fully established using the MAC layer 204 so that it is configured for application and/or IP layer communication packets prior to termination of the previously existing communication link 120 between the station 110 and the access point 104, which used the MAC layer 202.

When the new communication link 130 between the station 110 and the access point 104 is initially being established using the MAC layer 204 (e.g., the authentication process, reassociation process, EAP authentication and key exchange and until the station 110 transmits the designated signals 225 and 227), the new communication link 130 is initially established to facilitate transmission and reception of MAC layer communication packets (e.g., layer 2 communication packets under the OSI model) such that the station 110 and the access point 104 may not be configured to perform transmit and receive operations 211 associated with transmitting or receiving application and/or IP layer communication packets (e.g. layer 3 communication packets and/or above under the OSI model). That is, the new communication link 130 being established between the station 110 and the access point 104 can be used by the station 110 and the access point 104 for performing the necessary MAC layer processes to enable the transmission and reception of the application and/or IP layer communication packets but can prevent or prohibit the transmission and reception of application and/or IP layer communication packets until the station 110 is ready to transition from the existing communication link 120 between the station 110 (using the MAC layer 202) and the access point 102 to the new communication link 130 between the station 110 and the access point 104 using the MAC layer 204. Once the new communication link 130 is fully established and ready for transmitting and receiving application and/or IP layer communication packets, an additional communication between the station 110 and access point 104 signals (e.g., signals 225 and 227) to the access point 104 that the new link 130 is now ready for transmitting and receiving application and/or IP layer communication packets and that the new communication link 130 should be used for transmitting and receiving the application and/or IP layer communication packets, and the old communication link 120 between the station 110 (using the MAC layer 202) and the access point 102 should be terminated.

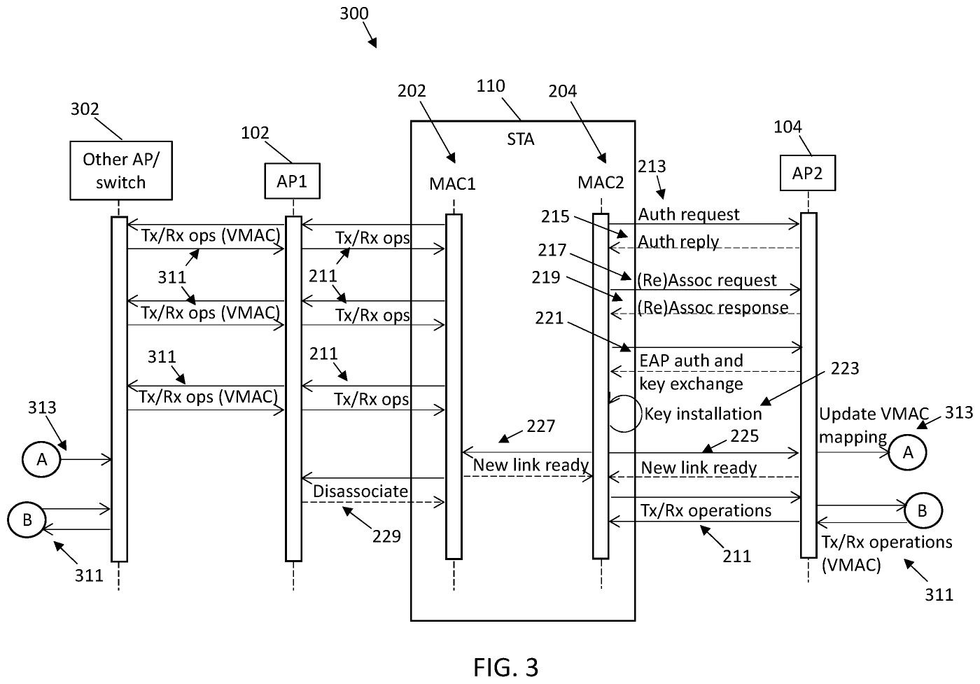

FIG. 3 illustrates a roam handover process 300 in accordance with embodiments of the present disclosure. The roam process 300 generally corresponds to the roam process 200 except that a virtual MAC address can be forwarded to the physical hardware address of MAC layer 202 or MAC layer 204 and the access point 104 must propagate updated virtual MAC address mappings in the network 100. The various operations utilized in the roam process 300 that correspond to the operations utilized in roam process 200 (e.g., denoted as 211-229) are not repeated with reference to the process 300 for the sake of brevity and such operations may be referred to as described with reference to FIG. 2 which apply equally to the process 300. In addition to transmit and receive operation 211 between the station 110 (using MAC layer 202) and the access point 102, the access point 102 can perform transmit and receive operations 311 between the access point 102 and another device 302 (e.g., another access point, switch, etc.). In one example, to facilitate the transmit and receive operations 311, the access point 102 manages an association between a physical hardware address and a virtual hardware address associated with the MAC layer 202 so that the access point 102 uses the virtual hardware address when forwarding/routing application and/or IP layer communication packets to other nodes in the network 100 (e.g., the device 302) and uses the physical hardware address when forward application and/or IP layer communication packets to the station 110. Logically, both communication links (i.e. the existing communication link, denoted as reference number 120 in FIGS. 1A-B, between the MAC layer 202 and the access point 102 and the new communication link, denoted as 130 in FIGS. 1B-C, between the MAC layer 204 and the access point 104) can exist at the same time. Link transfer can be determined by a specified/designated signal (e.g., signals 225 and 227) to change the mapping of the virtual MAC address between the physical hardware addresses of the MAC layer 202 and the MAC layer 204. Using this approach, the source/destination MAC address must be translated from the physical hardware address to the virtual MAC address by the access point 102 or 104 as application and/or IP layer communication packets enter/leave the infrastructure of the network 100. In some cases, handling multiple IP address-to-MAC address mappings can add complexity, in particular, if the translation cannot be localized to access point link. With this approach, the virtual MAC address mappings are propagated throughout the infrastructure (to other device in the network 100), which can add to complexity. As an example, when the access point 104 receives the new link ready signal 225, the access point 104 can transmit updated virtual MAC address mappings 313 to the other devices 302 (e.g., other access points, switches, routers, hubs, gateways, servers, etc.) on the network 100 and transmit and receive operations 211 and 311 for application and/or IP layer communication packets can resume between the station 110 (using MAC layer 204) and the access point 104 and between the access point 104 and the other devices 302. As with the process 200, since the existing communication link 120 remains configured for transmit and receiver operations 211 to transmit and receive application or IP level communication packets while the new communication link is being established, connection errors during the roaming process 300 have no impact on network communication.

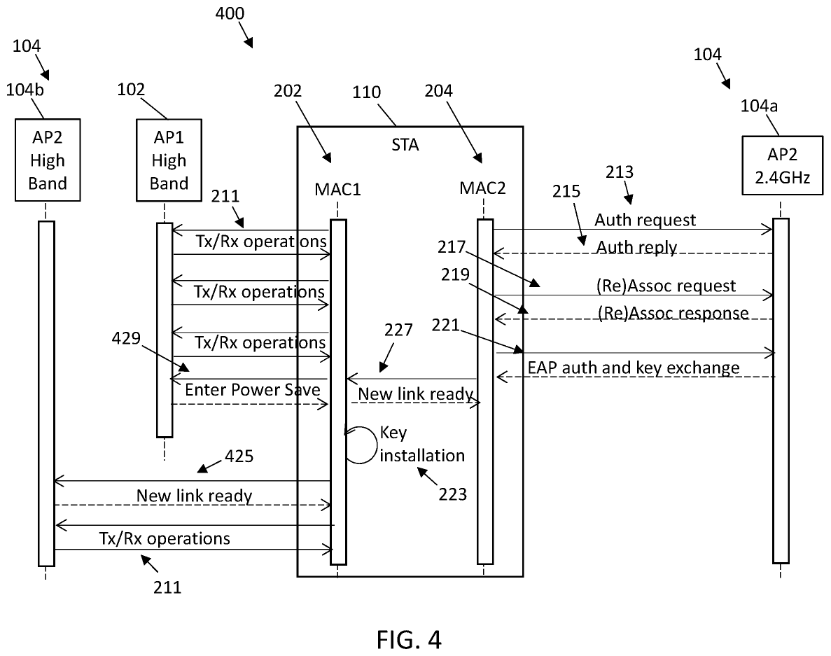

FIG. 4 illustrates a roam handover process 400 in accordance with embodiments of the present disclosure. As shown in FIG. 4, the station 110 can operate the two medium access control (MAC) layers 202 and 204 and the access points 102 and 104 can operate in two frequency bands a low band configured for 2.4 GHz and a high band configured for 5/6 GHz. The process 400 can implement high-band roaming (from the high band of access point to the high band 104b of the access point 104) using the 2.4 GHz band 104a of the access point 104 as proxy. The station 110 can operate the MAC layers 202 and 204 independently. In the present example, the MAC layer 202 can operate on the 5/6 GHz and the MAC layer 204 can operate on the 2.4 GHz band. As shown in FIGS. 1A-B and 4, the station 110, using the MAC layer 202 can have an established communication link 120 with the high band of the access point 102 over which the station 110 and the access point 102 can perform the transmit and receive operations 211 to transmit and receive application and/or IP layer communication packets. Advantageously, the process 400 can be used without full support of simultaneous transmitting and receiving on multiple bands.

To establish a new link 130 to access point 104 during a roam handover, the station 110 can use the inactive MAC layer 204 while the existing communication link 120 between the active MAC layer 202 and the access point 102 remains configured to transmit and receive application and/or IP layer communication packets (denoted by arrows 211). For example, using the MAC layer 204, the station 110 can perform operations including, but not limited to discovery and management operations involved in establishing the new communication link 130 with the 2.4 GHz band 104a of the access point 104, as well as any necessary security-related operations, such as authentication and key exchange. The MAC layer 204 and 2.4 GHz band 104a of the access point 104 can perform proxy operations to establish the new communication link 130 between the MAC layer 202 and the high band 104b of the access point 104. The station 110 and the 2.4 GHz band 104a of the access point 104 can perform the authentication process to transmit and receive authentication frames including the authentication request 213 transmitted by the station 110 (using MAC layer 204) and received by the 2.4 GHz band 104a of the access point 104 and the authentication response 215 is transmitted by the 2.4 GHz band of the access point 104 and received by the station 110 (using MAC layer 204). The station 110 and the 2.4 GHz band 104a of the access point 104 can perform the association process to transmit and receive (re)association frames including the reassociation request 217 transmitted by the station 110 (using MAC layer 204) and received by the 2.4 GHz band 104a of the access point 104 and the reassociation response 219 is transmitted by the 2.4 GHz band 104a of the access point 104 and received by the station 110 (using MAC layer 204). The station 110 (using MAC layer 204) and the 2.4 GHz band 104a of the access point 104 can perform an additional authentication process to transmit and receive the EAP authentication and key exchange frames 221, after which the MAC layer 204 can send a specified/designated signal 227 to the MAC layer 202 that the new communication link 130 is ready and MAC layer 202 of the station 110 can enter a power save mode and transmit a corresponding signal 429 to the access point 102 to cease transmitting and receiving application and/or IP layer communication packets, e.g., by suspending transmit and receive operations between the station 110 and the access point 102. The station 110 can subsequently install the key 223 (from the key exchange 221 on MAC layer 204) on the MAC layer 202 and can transmit an action frame 425 (e.g., new link ready frame) to the high band 104b of the access point 104 to transfer the link from the previously existing communication link 120 between the station 110 (using the MAC layer 202) and the high band of the access point 102 to the new communication link 130 between the station 110 (using the MAC layer 202) to the high band 104b of the access point 104 such that transitioning the communication link to the high band 104b of the access point 104 uses the association and key derived from communication link established between the MAC layer 204 and the 2.4 GHz band 104a of the access point 104. In some instances, a connection error may occur during the roaming process 400. As an example, the station 110 can fail to establish the new communication link 130 with the access point 104 and may attempt to establish the new communication link with the access point a configured number of times and/or upon failure (or the nth failure) may attempt to form a new communication link with another access point (e.g., a further or third access point 106). Since the existing communication link 120 remains configured for transmit and receiver operations 211 to transmit and receive application or IP level communication packets while the new communication link is being established and until the signal 227 is sent, connection errors that occur during the roaming process 200 before the signal 227 is sent have no impact on network communication. In response to the action frame 429, the access point 104 can update the association table so that devices in the network 100 direct any queued and future application and/or IP Layer communication packets to the MAC layer 202 of the station 110 via the access point 104. Such a “proxy” roam can provide additional informational elements (IEs) to specify on which device-side MAC address, access point-side BSSID, and band/channels the associating is occurring for purposes of updating the association table of the access point 104. Once the new communication is transitioned to the high band 104b of the access point 104, the high band 104b of the access point 104 can resume the transmit and receive operations 211 for application and/or IP layer communication packets on the new communication link 130. Using this approach, the new communication link 130 between the station 110 and the access point 104 can be fully established using the MAC layer 204 prior to transferring the new communication link 130 to the MAC layer 202 after the previously existing communication link 120 on the MAC layer 202 is terminated.

When the new communication link 130 between the station 110 and the access point 104 is initially being established on the 2.4 GHz band 104a of the access point using the MAC layer 204 (e.g., the authentication process, reassociation process, EAP authentication and key exchange and until the station 110 transmits the specified/designated signals 227), the new communication link 130 is initially configured such that the station 110 and the 2.4 GHz band 104a of the access point 104 cannot transmit or receive application and/or IP layer communication packets (e.g., cannot perform transmit and receive operation 211). That is, prior to the specified/designated signal, the communication link can be used by the station 110 and the access point 104 for performing the necessary MAC layer processes to enable the transmission and reception of the application and/or IP layer communication packets but can prevent or prohibit the transmission and reception of application and/or IP layer communication packets until the station 110 is ready to transition from the existing communication link 120 between the station 110 (using the MAC layer 202) and the access point 102 and the new communication link 130 between the station 110 and the high band 104b of the access point 104 also using the MAC layer 202.

In scenarios in which the station 110 is utilizing multi-link operation (MLO) such that the station 110 is already using the 2.4 GHZ and high bands of the station 110, the MLO is terminated by the station 110 prior to roaming such that existing communication link 120 continues transmitting and receiving application and/or IP layer communication packets on high band (5/6 GHz) of the station 110 and so that the roaming process 400 can be performed on the 2.4 GHz band of the station 110. Once the new communication link 130 is fully established between the station 110 and the high band 104b of the access point 104, MLO is re-established on the high band of the station 110 (using MAC layer 202), and the prior high band communication link on the station 110 (using the MAC layer 202) is terminated. In scenarios in which the station 110 is not utilizing MLO, access point discovery is performed in 2.4 GHz band and additional information on co-located high band access points and relative RSSI/Tx power may be obtained.

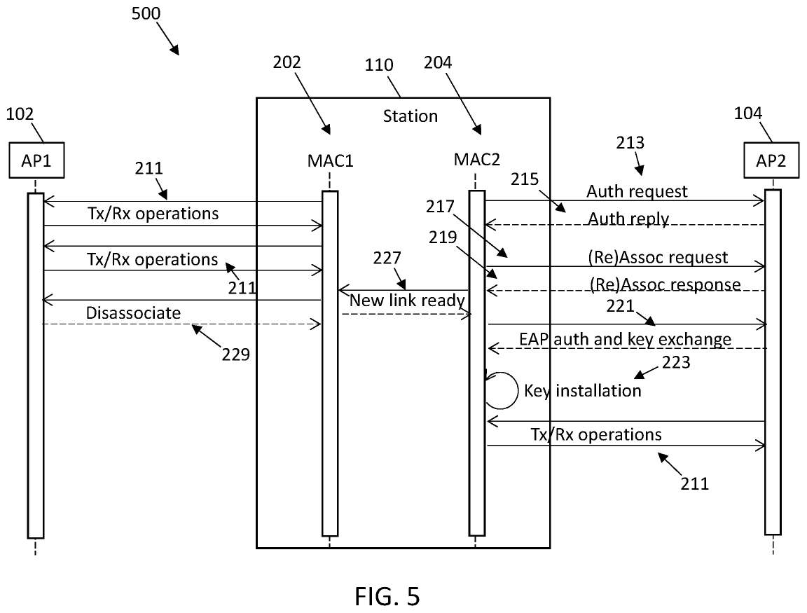

FIG. 5 illustrates a roam handover process 500 in accordance with embodiments of the present disclosure. The station 110 can operate the two medium access control (MAC) layers 202 and 204. The station 110 can operate the MAC layers 202 and 204 independently. As an example, one MAC layer can operate on a 2.4 GHz band and the other MAC layer can operate on a 5/6 GHz band. As another example, the device can operate the MAC layers on the 5 and 6 GHz bands independently (e.g., one MAC layer on the 5 GHz band and the other MAC layer on the 6 GHz band) and/or the station 110 can operate the MAC layers in the same band on separate channels or sub-bands. The process 500 can utilize the MAC layers 202 and 204 to facilitate roaming between access points (e.g., access points 102 and 104) while maintaining an operable active communication link with one of the access points until the new communication link is fully established.

As shown in FIGS. 1A-C and 5, the station 110, using the MAC layer 202 can have the established communication link 120 with the access point 102 over which the station 110 and the access point 102 can perform transmit and receive operations 211 to transmit and receive application and/or IP layer communication packets. To establish the new communication link 130 to access point 104 during a roam handover, the station 110 can use the inactive MAC layer 204 while the existing communication link 120 between the active MAC layer 202 and the access point 102 remains configured to transmit and receive application and/or IP layer communication packets (denoted by arrows 211). For example, using the MAC layer 204, the station 110 can perform MAC layer operations including, but not limited to discovery and management operations involved in establishing the new communication link 130 with the access point 104. The station 110 and the access point 104 can perform the authentication process to transmit and receive authentication frames including an authentication request 213 transmitted by the station 110 (using MAC layer 204) and received by the access point 104 and an authentication response 215 transmitted by the access point 104 and received by the station 110 (using MAC layer 204). The station 110 and the access point 104 can perform the association process to transmit and receive (re)association frames including a reassociation request 217 transmitted by the station 110 (using MAC layer 204) and received by the access point 104 and a reassociation response 219 transmitted by the access point 104 and received by the station 110 (using MAC layer 204). After the discovery and management operations involved in establishing the new communication link 130 with the access point 104 are completed and in response to the reassociation response from the access point 104, the station 110 can send a specified/designated signal (new link ready signal) 227 from the MAC layer 204 to the MAC layer 202 to transition transmission and reception of application and/or IP layer communication packets from the existing communication link 120 between the station 110 and the access point 102 (using the MAC layer 202) to the new communication link 130 established between the station 110 (using the MAC layer 204) and the access point 104. After the designated signal 227 is transmitted, the station 110 (using the MAC layer 202) can transmit a disassociate frame to the access point 102 to terminate the previously existing communication link 120 (ceasing the transmit and receive operations 211 on the communication link 120) and the station 110 (using the MAC layer 204) and the access 104 can resume the transmit and receive operations 211 for the application and/or IP layer communication packets on the new communication link 130. After the new communication link 130 is established and (which in the present example, occurs in response to receipt of the reassociation response), the station 110 (using MAC layer 204) and the access point 104 can perform an additional security/authentication process to transmit and receive EAP authentication and key exchange frames 221. The station 110 can install the key 223 after the key exchange. Using this approach, the new communication link 130 between the station 110 and the access point 104 is fully established using the MAC layer 204 after the EAP authentication and key exchange (if any). As a result, the process 500 corresponds to a partial make-before-break process where the MAC layers 202 and 204 establish association separately but there may be a delay between the disassociation frame 229 on the previously existing communication link 120 and the resumption of transmit and receive operation 211 for the application and/or IP layer communication packets on the new communication link 130. In some instances, a connection error may occur during the roaming process 500. As an example, the station 110 can fail to establish the new communication link 130 with the access point 104 and may attempt to establish the new communication link with the access point 104 a configured number of times and/or upon failure (or the nth failure) may attempt to form a new communication link with another access point (e.g., a further or third access point 106). Since the existing communication link 120 remains configured for transmit and receiver operations 211 to transmit and receive application or IP level communication packets while the new communication link is being established and until the signal 227 is sent, connection errors that occur during the roaming process 500 before the signal 227 is sent have no impact on network communication. The transition to the new communication link 130 occurs upon (re)association exchange (e.g., request 217 and response 219 as the specified/designated signal). For fast transition (FT) roaming under the IEEE 802.11 standards, this can achieve many of the same benefits as make-before-break (e.g., as described in FIG. 2), but some delays associated with full IEEE 802.1x authentication, key exchange and key installation time can exist. The process 500 is estimated to reduce the roam time between the previously existing communication link to the new communication link for the resumption of transmission and receive operations 211 operations compared to conventional roam handover processes that utilize a single MAC layer. A slight difference in the reduction of the roam time between transmit operations and receive operations can exist because transmission operations can continue on the MAC layer 202 until (re)association request is sent while reception operations can continue on the MAC layer 202 until the (re)association response received. The reduction of the roam time for the reception operations can decrease or eliminate loss of application and/or IP layer communication packets queued at the access point 102 prior to transferring from the previously existing communication link 120 to the new communication link 130. Furthermore, switching from the MAC layer 202 to MAC layer 204 during the roam process 500 may reduce or eliminate delay associated with power save or disassociation operations and channel switching.

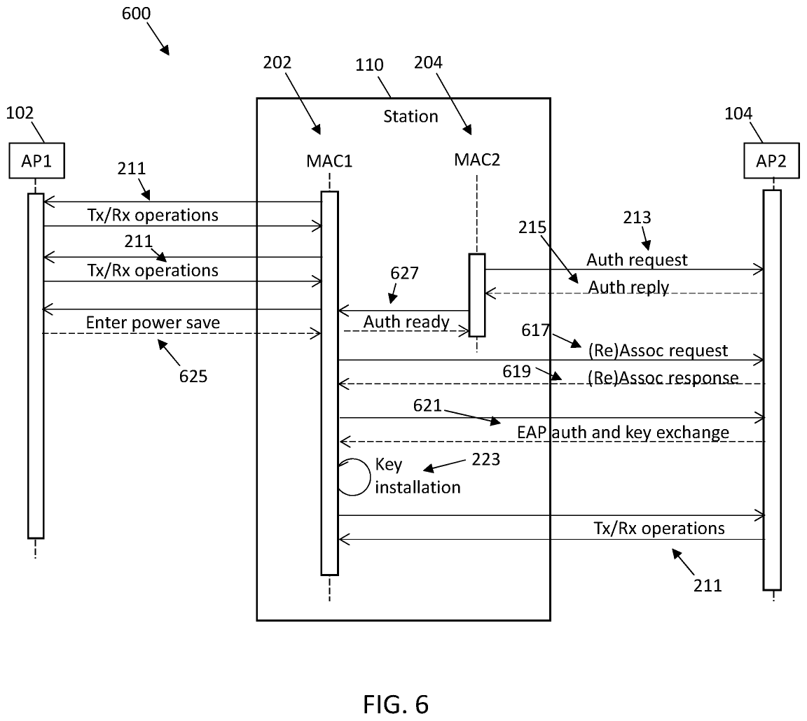

FIG. 6 illustrates a roam handover process 600 in accordance with embodiments of the present disclosure. The station 110 can operate the two medium access control (MAC) layers 202 and 204. The station 110 can operate the MAC layers 202 and 204 independently. As an example, one MAC layer can operate on a 2.4 GHz band and the other MAC layer can operate on a 5/6 GHz band. As another example, the device can operate the MAC layers on the 5 and 6 GHz bands independently (e.g., one MAC layer on the 5 GHz band and the other MAC layer on the 6 GHz band) and/or the station 110 can operate the MAC layers in the same band on separate channels or sub-bands. The process 200 can utilize the MAC layers 202 and 204 to facilitate roaming between access points (e.g., access points 102 and 104) while maintaining an operable active communication link with one of the access points when the station 110 (using the MAC layer 204) and the access point 104 perform the authentication process by transmitting the authentication frames. In the present example, the MAC layer 204 can spoof the hardware address of the MAC layer 202.

As shown in FIGS. 1A-C and 6, the station 110, using the MAC layer 202 can have the established communication link 120 with the access point 102 over which the station 110 and the access point 102 can perform transmit and receive operations 211 to transmit and receive application and/or IP layer communication packets. To establish the new communication link 130 to access point 104 during a roam handover, the station 110 can use the inactive MAC layer 204 while the existing communication link 120 between the active MAC layer 202 and the access point 102 remains configured to transmit and receive application and/or IP Layer communication packets (denoted by arrows 211). For example, using the MAC layer 204, the station 110 can perform MAC layer operations including, but not limited to discovery and management operations involved in establishing the new communication link 130 with the access point 104. The station 110 (using the MAC layer 204) and the access point 104 can perform the authentication process to transmit and receive authentication frames including an authentication request 213 transmitted by the station 110 (using MAC layer 204) and received by the access point 104 and an authentication response 215 transmitted by the access point 104 and received by the station 110 (using MAC layer 204). After the authentication process is completed, the MAC layer 204 can send a specified/designated signal 627 (e.g., authentication ready signal) to the MAC layer 202. The MAC layer 202 maintains communication link 120 with the access point 102 until the specified/designated signal 627 is received and in response to the specified/designated signal 627, the station 110 (using the MAC layer 202) transmits a power save frame 625 to the access point 102 to suspend communication on the existing communication link 120 between the station 110 and the access point 102. In some instances, a connection error may occur during the roaming process 600. As an example, the station 110 can fail to establish the new communication link 130 with the access point 104 and may attempt to establish the new communication link with the access point a configured number of times and/or upon failure (or the nth failure) may attempt to form a new communication link with another access point (e.g., a further or third access point 106). Since the existing communication link 120 remains configured for transmit and receiver operations 211 to transmit and receive application or IP level communication packets while the new communication link is being established and until the signal 627 is sent, connection errors that occur during the roaming process 600 before the signal 627 is sent have no impact on network communication.

The process 600 offloads the authentication process to the MAC layer 204 (spoofing the hardware address of the MAC layer 202), after which the roam process proceeds on the MAC layer 202 beginning from the (re)association process. The (re)association process with known authenticated access point 104 can proceed similarly to fast transition roaming over the distribution system (FT-over-DS), where the station 110 communicates with the access point 104 through the access point 102. For example, the communication between the station 110 and the access point 104 is carried in FT action frames between the station 110 and the current access point 102 and is then sent through a network controller in the network 100 to the access point 104.

The station 110 (using the MAC layer 202) and the access point 104 can perform the association process to transmit and receive (re)association frames including a reassociation request 617 transmitted by the station 110 (using MAC layer 202) and received by the access point 104 and a reassociation response 619 transmitted by the access point 104 and received by the station 110 (using MAC layer 202). In response to receipt of the reassociation response, the station 110 (using MAC layer 202) and the access point 104 can perform an additional security/authentication process to transmit and receive EAP authentication and key exchange frames 621. The station 110 can install the key 223 after the key exchange and transmit and receive operations 211 for application and/or IP layer communication packets can resume on the new communication link 130. Using this approach, the new communication link 130 between the station 110 and the access point 104 is fully established using the MAC layer 202 after the EAP authentication and key exchange (if any). As a result, the process 500 corresponds to a partial make-before-break process where the authentication process is offloaded to the MAC layer 204, but the remainder of the process 600 is performed using the MAC layer 204 to establish the association with the access point 104. As a result, there may be a delay between the power save frame 625 on the previously existing communication link 120 and the resumption of transmit and receive operation 211 for transmitting and receiving application and/or IP Layer communication packets on the new communication link 130. The process 600 is estimated to reduce the roam time between the previously existing communication to the new communication by approximately six (6) milliseconds for the resumption of transmission and reception operations compared to conventional roam handover processes that utilize a single MAC chain. The reduction of the roam time 604 for the transmission and reception operations can decrease or eliminate loss of voice and/or data packets.

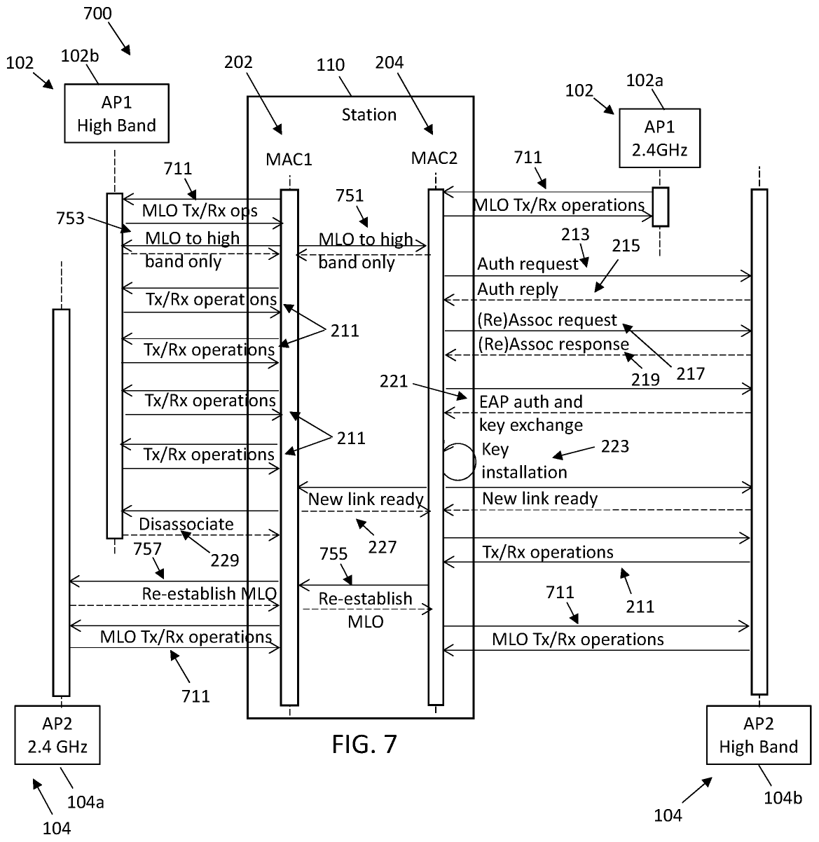

FIG. 7 illustrates a roam handover process 700 in accordance with embodiments of the present disclosure. The station 110 can operate two medium access control (MAC) layers 202 and 204. The station 110 can operate the MAC layers 202 and 204 independently. In the present example, one MAC layer can operate on a 2.4 GHz band and the other MAC layer can operate on a 5/6 GHz band. In other examples, the station 110 can operate the MAC layers on the 5 and 6 GHz bands independently (e.g., one MAC layer on the 5 GHz band and the other MAC layer on the 6 GHz band) and/or the station 110 can operate the MAC layers in the same band on separate channels or sub-bands. The process 200 can utilize the MAC layers 202 and 204 to facilitate roaming between access points (e.g., access points 102 and 104) while maintaining an operable active communication link with one of the access points until the new communication link is fully established.

As shown in FIGS. 1A-C and 7, the station 110, using the MAC layer 202 can have the established communication link 120 with the access point 102 over which the station 110 and the access point 102 can perform multi-link operation (MLO) transmit and receive operations 711 for transmitting and receiving application and/or IP Layer communication packets on the MAC layers 202 and 204 using the 2.4 GHz band 102a and the high band 102b of the access point 102, respectively. When the station 110 initiates a roam handover, it may not be possible to maintain MLO operation during the roam process 700 and the station 110 may have to transition out of MLO operation prior to initiating the roam process 700. Once the new communication link 130 is established and configured for transmitting and receiving application and/or IP layer communication packets, the station 110 can transition back into MLO operation as necessary following the roam handover. To facilitate the process 700, the station 110 can cease MLO transmissions on the bands (based on a signal 751) and can continue transmit and receive operations 211 for application and/or IP layer communication packets on one of the bands (e.g., the high band 102b of the access point 102) using the MAC layer 202 and the station 110 proceeds with the roam process 700 using MAC layer 204. The transmit and receive operations 211 can continue for application and/or IP layer communication packets on communication link 120 (with one of the bands of the access point 120) until the new communication link 130 has been established and is configured for transmitting and receiving application and/or IP layer communication packets. That is, to establish the new communication link 130 to access point 104 during the roam handover, the station 110 can use the MAC layer 204 while the existing communication link 120 between the active MAC layer 202 and the access point 102 remains configured for application and/or IP Layer communication packets without MLO (denoted by the arrows 211). For example, using the MAC layer 204, the station 110 can perform MAC layer operations including, but not limited to discovery and management operations involved in establishing the new communication link 130 with the high band 104b of the access point 104, as well as any necessary security-related operations, such as authentication and key exchange. The station 110 and the high band 104b of the access point 104 can perform the authentication process to transmit and receive authentication frames including the authentication request 213 transmitted by the station 110 (using MAC layer 204) and received by the high band 104b access point 104 and the authentication response 215 transmitted by the high band 104b of the access point 104 and received by the station 110 (using MAC layer 204). The station 110 and the high band 104b of the access point 104 can perform the association process to transmit and receive (re)association frames including a reassociation request 217 transmitted by the station 110 (using MAC layer 204) and received by the high band 104b of the access point 104 and a reassociation response 219 transmitted by the high band 104b of the access point 104 and received by the station 110 (using MAC layer 204). The station 110 (using MAC layer 204) and the high band 104b of the access point 104 can perform an additional authentication process to transmit and receive EAP authentication and key exchange frames 221, after which the station 110 can install the key. After the discovery, management, and security related operations involved in establishing the new communication link 130 with the access point 104 are completed, using the MAC layer 204, the station 110 can transmit a specified/designated signal (new link ready signal) 225 to the high band 104b of the access point 104 and a specified/designated signal 227 to the MAC layer 202 to transition transmission and reception of application and/or IP layer communication packets from the existing communication link 120 between the station 110 and the high band 102b of the access point 102 (using the MAC layer 202) to the new communication link 130 established between the station 110 (using the MAC layer 204) and the high band 104b of the access point 104. After the designated signals 225 and 227 are transmitted, the station 110 (using the MAC layer 202) can transmit a disassociate frame to the high band 102b of the access point 102 to cease transmitting and receiving application and/or IP layer communication packets and terminate the previously existing communication link 120 and the station 110 (using the MAC layer 204) and the high band 104b of the access point 104 can resume the transmit and receive operations 211 for application and/or IP layer communication packets on the new communication link 130. Using this approach, the new communication link 130 between the station 110 and the access point 104 can be fully established and ready for transmission and reception of application and/or IP layer communication packets using the MAC layer 204 prior to termination of the previously existing communication link 120 between the station 110 and the access point 102, which used the MAC layer 202. In some instances, a connection error may occur during the roaming process 600. As an example, the station 110 can fail to establish the new communication link 130 with the access point 104 and may attempt to establish the new communication link with the access point a configured number of times and/or upon failure (or the nth failure) may attempt to form a new communication link with another access point (e.g., a further or third access point 106). Since the existing communication link 120 remains configured for transmit and receiver operations 211 to transmit and receive application or IP level communication packets while the new communication link is being established and until the signal 227 is sent, connection errors that occur during the roaming process 600 before the signal 227 is sent have no impact on network communication.

When the new communication link 130 between the station 110 and the high band 104b of the access point 104 is initially being established using the MAC layer 204 (e.g., the authentication process, reassociation process, EAP authentication and key exchange and until the station 110 transmits the specified/designated signals 225 and 227), the new communication link 130 is initially established such that the station 110 and the high band 104b of the access point 104 is not ready to transmit or receive application and/or IP layer communication packets (e.g., not ready to perform transmit and receive operation 211). That is, the new communication link 130 can be used by the station 110 and the access point 104 for performing the necessary MAC layer processes to enable the transmission and reception of the application and/or IP layer communication packets but can prevent or prohibit the transmission and reception of application and/or IP layer communication packets until the station 110 is ready to transition from the existing communication link 120 between the station 110 (using the MAC layer 202) and the access point 102 and the new communication link 130 between the station 110 and the high band 104b of the access point 104 using the MAC layer 204. Once the new communication link 130 is fully established, an additional communication between the station 110 and access point 104 signals (e.g., specified/designated signals 225 and 227) to the access point 104 that the new link 130 is now ready and that the new communication link 130 should be used for transmitting and receiving application and/or IP layer communication packets, and the old communication link 120 between the station 110 (using the MAC layer 202) and the access point 102 should be terminated. After the transmit and receive operations 211 for application and IP layer communication packets have resumed on the new communication link 130 between the station 110 (using the MAC layer 204) and the high band 104b of the access point 104, the MAC layer 204 can send a signal 755 to the MAC layer 202 to re-establish MLO communication, and in response, the station 110 (using the MAC layer 202) can send a signal 757 to the 2.4 GHz band 104a of the access point 104 to re-establish MLO communication. In response to the signals 755 and 757, MLO transmit and receive operations 711 for application and/or IP layer communication packets can resume on the 2.4 GHZ band 104a and the high band 104b of the access point 104. As the roam handover process 70 provides for a make-before-break roam handover, the process 700 enables identification of a transition in progress from network or infrastructure side and can be leveraged in order to further reduce infrastructure-side packet loss which can result from packet queueing at the old access point (e.g., access point 102).

FIG. 8 is a block diagram of an example embodiment of the station 110 configured to perform the operations and processes described herein in accordance with embodiments of the present disclosure. The station 110 can take a variety of forms, including a barcode scanner, an RFID reader, a smart phone, a wearable computer, a tablet computer, laptop, printer, and/or other devices having radiofrequency transceivers configured to access and/or communication with the network 100 as described herein. The station 110 can include various components including, for example, a processor 802 (e.g., one or more central processing units) operatively coupled to a non-transitory computer readable storage medium, such as a memory 804, one or more input/output devices 806, an image capturing system 808, illumination device(s) 810, sensor(s) 812, and a communications interface 814, and an antennas 816.

The image capturing device 808 can include one or more image sensors 818 configured to acquire images of a scene. The image sensor(s) 818 can include an array of photosensitive cells or pixels defining an image frame. Some examples of the image sensor 110 can include a charge coupled device (CCD), a complementary metal-oxide semiconductor (CMOS) imager, and/or another type of image sensor. Common components associated with reading out and processing the charge collected by the image sensor 110, including for example, shift registers, amplifiers, timing/clock generators, analog-to-digital converters, digital-to-analog converters, and/or other components can also be denoted by the image sensor 110.

The illumination devices 810 can emit diffuse and/or direct light over an illumination field. The light emitted by the illumination devices 810 can be emitted at one or more wavelengths and/or intensities in the light spectrum, including, for example, the visible light spectrum, the infrared light spectrum, and/or the ultraviolet light spectrum. The illumination devices 810 can be continuous light sources, intermittent light sources, or signal-controlled light sources, such as a light source triggered by one or more of the I/O devices 806, an event, an action, and the like. As a non-limiting example, the illumination devices 118 can be light emitting diodes (LEDs) controlled by signals from the processor 802. In an example application, the illumination devices 810 can emit light to illuminate an object in a scene before and/or during image acquisition by the image sensor 818.

The processor 802 includes, for example, one or more microprocessors, central processing units (CPUs), graphics processing units (GPUs), microcontrollers, controllers, field programmable gate arrays (FPGAs), applicant specific integrated circuits (ASICs), and/or any suitable type of logic circuits. The processor 802 can control an operation of the I/O devices 806, the image capturing system 808, the illumination devices 810, the sensor(s) 812, and the communications interface 814. In one example application, the processors 802 can control the illumination device 810 and the image capturing system to acquire images of an object that include encoded indica, e.g., in the form of barcodes, and can use the acquired images to detect and/or decode the encoded indicia present in the images. One or more image processing and/or object recognition techniques and/or algorithms can be employed by the processor 802 to detect and decode the encoded indicia.

The station 110 can include any number or types of non-transitory computer- or machine-readable storage devices or memory (e.g., volatile memory, non-volatile memory, etc.) 804 accessible by the processor 802. The processor 802 interacts with the memory 804 to obtain, for example, computer- or machine-readable instructions or code stored in the memory 804. The processor 802 can execute the computer- or machine-readable instructions or code to implement, for example, embodiments of the present disclosure via one or more operations, processes, routines, and/or functions. Additionally or alternatively, computer- or machine-readable instructions corresponding to the example operations described herein may be stored on one or more removable storage devices (e.g., a magnetic storage drive, an optical storage drive, solid state drive, a compact disc (CD), a digital versatile disk (DVD), a removable flash memory, etc.) that may be operatively coupled to the processor 802 to provide access to the computer- or machine-readable instructions stored thereon. The memory 804 can also store images acquired by the image sensor 110; image data associated with the images acquired by the image sensor 818; encoded information from the indicia captured in the images; decoded information from the decoded indicia captured in the images; and/or any other information or data.

The I/O devices 806 can include a display 820 (including, e.g., touch screen displays), a navigation device 822 (e.g., a mouse, a trackball, a capacitive touch pad, a joystick, etc.), buttons 824, switches 826, indicator lights 828, keypads/keyboard 830, a microphone 832, speakers 834, printhead 836, and/or other devices. As an example, a user or other device can actuate, manipulate, and/or control the display 820, the navigation device 822, buttons 824, switches 826, keypads/keyboard 830, and/or microphone 832 and the processor 802 can execute one or more instructions or code in response to the input. As another example, the display 820, indicator lights 828, speakers 834, and/or printhead 836 can be actuated or controlled by the processor 802 to output data or information in response to operations performed by the processors 802, e.g., based on execution of the computer- or machine-readable instructions and/or the input from the user or another device.

The sensors 812 can be included in the station 110 to sense or detect environmental, functional, or operational conditions associated with the station 110. As an example, the sensors 812 can include a light sensor (e.g., a photosensitive sensor) that can detect an illuminance of the environment within which the station is disposed. The processor 802 can receive an output from the sensors 812 and can control one or more operations or parameters of the station 110 in response to the output of the sensors 812. As an example, the sensors 812 can include an accelerometer that sense x-y-z acceleration data associated with a movement of the station 110.

The station 110 can also include any number and/or type(s) wired and/or wireless communication interface 814 that facilitates communication with the other devices via the network 100. The communication interface 814 can operate in accordance with any suitable interface(s), protocol(s), signal(s), connector(s), etc. like, for example, a TCP/IP interface, a Wi-Fi™ interface (according to the IEEE 802.11 family of standards), cellular interface (e.g., using GSM, GPRS, CDMA, GPRS, 2G/GSM, 3G, 4G/LTE, EDGE, 5G), a Ethernet transceiver, a universal serial bus (USB) interface, a Bluetooth® interface, a near field communication (NFC) interface, an infrared transceiver, a satellite network radio, a cable modem, a digital subscriber line (DSL) modem, a dialup modem, or any other suitable communication protocols or standards. In the present example, the communication interface 814 is a radiofrequency communication interface configured to wireless communication with the network (e.g., via the access points 102 and 104 as described herein).

The communication interface 810 for implementing embodiments of the roaming handover processes described herein (e.g., embodiments of the processes 200, 300, 400, 500, 600, and/or 700). The communication interface 810 can include one or more radio transceivers 840 (including a transmitter and receiver) for transmitting and/or receiving radiofrequency signals via the antennas 816, and the medium access control (MAC) layers 202 and 204 of the station 110, which are independently controlled interfaces that are operatively coupled to the processor 844. In one example, the communication interface 810 can include two transceivers 840 and two antennas 816 (one for each transceiver) and the MAC layers 202 and 204 can each be associated with one of the transceivers 840. The MAC layer 202 can include a MAC controller 844a that includes a processor for executing a series of state machines which process outgoing and incoming data packets transmitted and received, respectively, by a first one of the one or more transceivers 840. The MAC layer 204 can include a MAC controller 844b that includes a processor for executing a series of state machines which process outgoing and incoming data packets transmitted and received, respectively, by a second one of the one or more transceivers 840. The MAC controller 844a of the MAC layer 202 can generate and manage an upper MAC layer 846a and instances of a lower MAC layer 848a. The MAC controller 844b of the MAC layer 204 can generate and manage an upper MAC layer 846b and instances of a lower MAC layer 848b. The upper MAC layers 846a and 846b is configured for packet management and communicates with the lower MAC layers 848a and 848b. The lower MAC layers 848a and 848b can be used by the MAC controllers 842a and 842b, respectively, to perform link specific functionalities for establishing communication links with access points (e.g., access points 102 and 104) and roaming between the access points.

Embodiments of the roam handover processes (e.g., processes 200, 300, 400, 500, 600, and/or 700) can involve determining how packets are handled for a given MAC/hardware address, and how these packets are directed between the MAC layer 202 and the MAC layer 204 for the roam handover processes. In one example, for the processes 200, 300, 400, 500, 600, and/or 700, the MAC layers 202 and 204 can share the same physical hardware address and have different virtual hardware addresses. The virtual hardware address for the MAC layer 202 can be associated with the physical hardware address for the existing communication link between the station 110 and the access point 102. An infrastructure mechanism for determining when the new communication link is ready for transmission of application and IP layer communication packets can be used (e.g., the signals 225 and 227) after which the corresponding virtual hardware address for the MAC layer 204 can be associated with the physical hardware address and the virtual hardware address of the MAC layer 202 can be disassociated from the physical hardware address (and the previously existing communication link can cease communication with the access point 102). Using this approach, the transfer of application and/or IP layer communication packets from the previously existing communication link to the new communication link can be triggered by a specified frame. As an example, in the process 200 the transfer from the previously existing communication link to the new communication link can be triggered by a separate frame independent of establishing association (e.g., the signals 225 and 227), as opposed to implicitly as the new access point association is established.

In another example, for the processes 200, 300, 400, 500, 600, and/or 700, the MAC layers 202 and 204 can have different physical hardware addresses and can share a virtual hardware address. The network infrastructure (e.g., access points 102, 104) performs forwarding and translation between the virtual hardware address and the physical hardware addresses for the MAC layers 202 and 204 depending on which communication link is considered the live communication link. The translation can be dictated by a separate frame independent of establishing the network association (e.g., the signals 225 and 227), as opposed to implicitly as the new communication link is established. For example, for the process 300, in response to the signals 225 and 227, the new communication link becomes live by associating the corresponding physical hardware address associated with the MAC layer 204 with the virtual hardware address and disassociating the physical address of the MAC layer 202 from the virtual hardware address (and the previously existing communication link ceases communication.

When the MAC layers share the same physical hardware address, but have different virtual addresses or when the MAC layers have different physical addresses, but share the same virtual address, support for establishing the new communication link between the station 110 and the access point 104 using the MAC layer 204 prior to termination of the existing active communication link between the station 110 and the access point 102 using MAC layer 202 can advantageously be accomplished while implementing access points (e.g., access points 102 and 104) using existing practices, for example, regarding managing the states of the associated station and its traffic routing.

In yet another example, for the processes 200, 300, 400, 500, 600, and/or 700, the MAC layer 204 can spoof the hardware address of the MAC layer 202. To use this approach, the (re)association frames can include a mechanism to establish association to an access point while transfer of the application and/or IP layer communication packets is deferred until an action frame (e.g., the “new link ready” frame or other specified frame) is used. The access point 104 can be configured to support establishing an association or communication link using MAC layer communication packets while being incapable of or prevented from transmitting and receiving application and/or IP layer communication packets. In this example, the link transfer is deferred from the (re)association response to the action frame signaling the new communication link is ready (e.g., signals 225 and 227). After the association is complete between the station 110 and the access point 104, the new communication link with the access point 104 allows only EAP related packets on communication link until the action frame signaling occurs. This approach can be particularly suited to fast roaming protocols under the IEEE 802.11 standards since authentication and key exchange can be performed with IEEE 802.11 management frames using MAC layer communication. Lack of additional authentication/key exchange following the (re)association response in FT (basic service set or BSS) roaming means that deferral of link transfer may be more straightforward in this case. For embodiments in which the MAC layer 204 spoofs the hardware address of MAC layer 202, in response to the new link ready signal 225, the access point 102 can be configured to transfer the identifier for the previous communication link to the access point 104 and the access point 104 can update the association table to allow transmit and receive operations 211 for application and/or IP layer communication packets to resume.

The above description refers to a block diagram of the accompanying drawings. Alternative implementations of the example represented by the block diagram includes one or more additional or alternative elements, processes and/or devices. Additionally or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A method for wireless roaming comprising:
operating, via a wireless communication device, a first communication link between the wireless communication device and a first access point using a first media access control (MAC) layer of the wireless communication device;
initiating, using a second MAC layer of the wireless communication device, a roaming handover with a second access point while the first communication link remains configured to transmit and receive application or IP layer communication packets;
ceasing transmission and reception of the application or IP layer communication packets on the first communication link after the roaming handover has been initiated; and
resuming the application or IP layer communication packets with a second communication link between the wireless communication device and the second access point upon completion of the roaming handover.

2. The method of claim 1, wherein resuming transmission and receipt of the application or IP layer communication packets with the second communication link comprises resuming transmission and reception of the application or IP layer communication packets using the first MAC layer of the wireless communication device.

3. The method of claim 2, wherein initiating the roaming handover comprises transmitting an authentication request from the wireless communication device to the second access point using the second MAC layer.

4. The method of claim 3, wherein initiating the roaming handover further comprises:
receiving an authentication reply from the second access point; and
sending an authentication ready signal from the second MAC layer to the first MAC layer,
wherein the wireless communication device ceases transmission and reception of the application or IP layer communication packets via the first communication link in response to the authentication ready signal.

5. The method of claim 4, further comprising:
transmitting a reassociation request from the wireless communication device to the second access point using the first MAC layer; and
resuming transmission and reception of the application or IP layer communication packets using the second communication link.

6. The method of claim 5, further comprising:
exchanging security and encryption frames with the second access point; and
installing the encryption key,
wherein exchanging and installing are performed prior to resuming transmission and reception of the application or IP layer communication packets using the second communication link.

7. The method of claim 2, wherein initiating the roaming handover comprises:
transmitting an authentication request from the wireless communication device to the second access point using the second MAC layer and a first frequency band;
transmitting a reassociation request from the wireless communication device to the second access point using the second MAC layer and the first frequency band; and
exchanging security and encryption frames with the second access point using the second MAC layer and the first frequency band;
sending a new link read signal from the second MAC layer to the first MAC layer after exchanging the security and encryption frames;
installing the encryption key on the first MAC layer; and
resuming transmission and reception of the application or IP layer communication packets via the second communication link using the first MAC layer and a second frequency band of the second access point,
wherein the wireless communication device ceases transmission and reception of the application layer communication via the first communication link in response to the new link ready signal.

8. The method of claim 1, wherein resuming transmission and reception of the application or IP layer communication packets with the second communication link comprises resuming transmission and reception of the application or IP layer communication using the second MAC layer of the wireless communication device.

9. The method of claim 8, wherein initiating the roaming handover comprises:
transmitting an authentication request from the wireless communication device to the second access point using the second MAC layer;
transmitting a reassociation request from the wireless communication device to the second access point using the second MAC layer; and
in response to the reassociation response, sending a new link ready signal from the second MAC layer to the first MAC layer; and
resuming transmission and reception of the application or IP layer communication packets using the second communication link,
wherein the wireless communication device ceases transmission and reception of the application or IP layer communication packets via the first communication link in response to the new link ready signal.

10. The method of claim 9, further comprising:
exchanging security and encryption frames with the second access point; and
installing the encryption key,
wherein exchanging and installing are performed prior to resuming transmission and reception of the application or IP layer communication packets using the second communication link and after the new link ready signal is sent.

11. The method of claim 9, further comprising:
exchanging security and encryption frames with the second access point; and
installing the encryption key,
wherein exchanging and installing are performed prior to resuming transmission and reception of the application or IP layer communication packets using the second communication link and before the new link ready signal is sent.

12. The method of claim 1, wherein initiating, using the second MAC layer of the wireless communication device, a roaming handover with the second access point while the first communication link remains configured for transmission and reception of the application or IP layer communication packets comprises establishing the second communication link that is limited to performing the MAC layer operations for the roam handover until the second communication link is ready to transmit and receive the application or IP layer communication packets in response to an action event signal that is transmitted to the second access point.

13. The method of claim 1, wherein the wireless communication device utilizes multi-link operation (MLO) communication for the first communication link in which the wireless communication device uses the first MAC layer to communicate with the first access point using a first frequency band or a first channel and uses the second MAC layer to communicate with the first access point using a second frequency band or a first channel,
in response to initiating the roam handover, the wireless communication device ceases the MLO communication on the second MAC layer while the first communication remains between the wireless communication device and the first access point using the first MAC layer and the first frequency band or the first channel, and
the wireless communication device uses the second MAC layer to initiate the roam handover with the second access point.

14. The method of claim 13, wherein initiating the roaming handover comprises:
transmitting an authentication request from the wireless communication device to the second access point using the second MAC layer and a first frequency band or a first channel of the second access point;
transmitting a reassociation request from the wireless communication device to the second access point using the second MAC layer and the first frequency band or the first channel of the second access point; and
exchanging security and encryption frames with the second access point using the second MAC layer and the first frequency band or the first channel of the second access point;
installing the encryption key on the second MAC chain;
sending a new link read signal from the second MAC layer to the first MAC chain; and
resuming transmission and reception of the application or IP layer communication packets via the second communication link using the second MAC layer and the first frequency band or the first channel of the second access point,
wherein the wireless communication device ceases transmission and reception of the application or IP layer communication packets via the first communication link in response to the new link ready signal.

15. The method of claim 14, further comprising:
establishing the MLO communication between the wireless communication device and the second access point using a second frequency band or a second channel of the second access point and the first MAC chain.

16. The method of claim 1, wherein the second communication link is established before the first communication link ceases transmission and reception of the application or IP layer communication packets and is utilized for transmission and reception of the application or IP layer communication packets after the first communication link ceases transmission and reception of the application or IP layer communication packets.

17. The method of claim 1, wherein the first MAC layer and the second MAC share a physical hardware address and have different virtual hardware addresses.

18. The method of claim 1, wherein the first MAC layer and the second MAC layer share a virtual hardware address and have different physical hardware addresses.

19. The method of claim 1, wherein the second MAC layer spoofs the hardware address of first MAC chain.

20. The method of claim 1, wherein a connection error occurs between the wireless communication device and the second access point during the roaming handover and the method further comprises:
reattempting to establish the second communication link with the second access point or a third access point while the first communication link remains configured to transmit and receive application or IP layer communication packets.

21. A wireless communication device comprising:
one or more antennas;
one or more radiofrequency transceivers configured to transmit and receive radiofrequency signals via the one or more antennas;
a first media access control (MAC) layer configured to operate a first communication link between the wireless communication device and a first access point; and
a second media access control (MAC) layer configured to initiate a roaming handover with a second access point while transmission and reception of application or IP layer communication packets continues on the first communication link, transmission and reception of the application or IP layer communication packets ceasing on the first communication link after the roaming handover has been initiated, and transmission and reception of the application or IP layer communication packets resuming on a second communication link between the wireless communication device and the second access point upon completion of the roaming handover.
